(19) United States
(12) Patent Application Publication
(10) Pub. No.: US 2010/0223129 A1
(43) Pub. Date: Sep. 2, 2010

(54) Method for matching the needs and interests of Internet users

(75) Inventor: Randall Blair Harmon, Tucson, AZ (US)

Correspondence Address: RANDALL HARMON, 9601 E 42nd ST, TUCSON, AZ, 85730, US

(73) Assignee: Randall Blair Harmon

(21) Appl. No.: 12/221,896

(22) Filed: Aug. 6, 2008

Related U.S. Application Data
(60) Provisional application No. 60/963,358, filed on Aug. 6, 2007.

(51) Int. Cl. G06Q 30/00; G06F 17/30; G06Q 50/00

(52) U.S. Cl. 705/14.52; 701/201; 705/14.53; 705/14.58; 705/14.61; 705/27; 707/705; 707/E17.107

(57) ABSTRACT

Internet service is no longer distributed by large Internet Service Providers such as America Online. From hotel owners, coffee shops, airports, libraries, government offices, schools and community networks, the availability to “log-on” is becoming more accessible and from a variety of sources everyday. In one embodiment of the invention, before an Internet user can access the Internet, a default URL address and web page appears on the screen that has a “terms of use” agreement contained within a text box, and blank text box fields for inputting the address of where the Internet user is accessing the Internet. The action of clicking on an “I agree” or “Accept” button seizes the address, references a website database of addresses belonging to businesses and special interests that are germane to the Internet user. In another embodiment of the invention, a URL address displays a web page that has blank text box fields for inputting the address of where the Internet user is accessing the Internet and does not contain a “terms of use” agreement. The results of clicking on the “Accept” button remain the same, displaying businesses and special interests that are germane to the Internet user.

This application claims priority of provisional application 60/963,358 filed Aug. 6, 2007.

### REFERENCES CITED

U.S. Pat. No. 7,231,405; U.S. Pat. No. 6,282,540; U.S. Pat. No. 7,240,049; U.S. Pat. No. 7,243,129; U.S. Pat. No. 7,231,405; U.S. Pat. No. 7,240,052 U.S. Pat. No. 6,269,361; U.S. Pat. No. 6,078,866; U.S. Pat. No. 6,271,840

### BACKGROUND OF THE INVENTION

1. Field of the Invention

This invention relates to web browsers, a terms of use agreement, and a faster method for rendering information, services and advertising of interest to Internet users which does not require a search query based on the input textual data or subject matter typical of major search engines.

The claimed method provides items of interest to Internet users and consumers and faster access of most popular in demand consumer items and interests; fewer clicks or steps; The claimed method renders information, services and advertising automatically by a pre-determined set of rules and logic. This method is based on, for example, consumer spending habits and tourism research, and displays only relevant material in a geographically centric area based on the address of the Internet user.

2. Description of Related Art

Major hotel chains in America have recently mandated the installation of high-speed Internet services for hotel guest use and thousands of independently owned hotels have also followed their lead. Providing Internet service to the public exposes the service provider to potential liabilities. Hotel guests have needs and interests, and often arrive at the lobby front desk with questions. For example, they may ask a clerk where to find a good place to eat, or what is recommended to see and do in and around the community. These needs and interests of tourists are nearly identical to the needs and interests of community residents.

To mitigate liability, before an Internet guest user can access the Internet, the service provider may have an initial web page displayed with legal terms and conditions that must be accepted before an open Internet session is allowed. The drawback to the service provider is the cost of prepared legal verbiage.

For the public to access information, it becomes a matter from which referral or information source. The Internet is becoming the most accessible information resource and is not limited the geographic boundaries of, for example, local telephone directories, newsprint and other forms of advertising. With a seemingly endless stream of information the challenge is to compose a search results and render data that is relevant to the Internet user. Search engines such as Google and YAHOO!, can be used as a resource. The drawback of present art, for example Internet search engines, is that: 1) they require textual input from the Internet user into a search, text box field; 2) the search process may require many steps; 3) the most commonly sought consumer items and interests are not readily organized and easily accessible; 4) they may display a search results that is not specific to the subject matter of interest; 5) the search information rendered may not be local to the Internet user; 6) to locate or get directions to a listing from the search results, the Internet user must take addition steps and is required to input, for example, “from and to” addresses; 7) search engines often render national meaningless advertising that is not pertinent, or geographically local to the Internet user.

Community websites are another resource to access information and may come in the form, for example, Tourism, Visitors and Convention websites as well as Chamber of Commerce websites. The drawback of present art is that it may focus on a singular community.

As for the interface of search engines and community resource websites, it would be advantageous to consumers if development in the art made popular consumer interests and relevant material more accessible requiring fewer steps.

### SUMMARY OF THE INVENTION

The availability to “log-on” is becoming more accessible from a variety of locations everyday. In one embodiment of the invention an initial splash page is first viewed by an Internet user before open Internet access is granted. For example, this restrictive feature can be a function of piece of data hardware called a router or Internet gateway. A router or Internet gateway is an electronic controller that processes data between two or more logical subnets or computer networks and manages received data on a logical interface and sends data to an outbound logical interface. Routers and Internet Gateways contain software that may be programmed to display a pre-determined, default website address or specific URL. This is called an initial splash page, or web page that serves as an interrupt function before an Internet user has open access to the Internet. The default splash page can consist of a welcoming informational page, a contractual page or an Internet Terms of Use page. This interrupt function can allow, for example, a correlation between the Internet venue (hotel, coffee house, etc.) or address of the Internet user and a database of businesses, advertisers or places of interest.

A set of identifying rules can be implemented to render pertinent information to an Internet user. In one embodiment of the invention, a default initial splash web page or a home web page has textual input fields, for example a location to enter the address of where a Internet user is accessing the Internet. For example, to render pertinent consumer information without a search query, the address location, the venue, the most popular consumer interests and spending habits can be contributors to the type information rendered and the type of advertisements rendered to the Internet user. An embodiment of the invention is a method to render information without a traditional Internet search engine query which contains one or more words, algorithms or other computer based logic.

In an embodiment of the invention, an action button with text in the form, for example, of an “I accept” or “I agree’ must be clicked then an Internet user is re-directed to a webpage where business listings, places of interest and advertisements are displayed that are pertinent to the consumer and are within a pre-defined geographic location. The web pages that are rendered are not dependent on a major search engine such as Yahoo!, Google or Lycos to deliver advertising content.

In conventional Internet searches that use known search engines, an Internet user initiates the search criteria in a text field descriptor box and a query is made to processors which display related referenced information. In known art, the processing of search requests includes analyzing received queries in order to provide a more concentrated understanding of the information an Internet user is seeking. A query may be comprised of one or more words to get the results an Internet user desires.

In the embodiment of the invention, the Internet user is not required to enter a search criteria, search terms or queries to see advertisements of businesses and services that meet their needs. For example, published research about the needs and services of hotel guests show the five top spending categories are: 1) Food and beverage; 2) Recreation and entertainment; 3) Shopping; 4) Ground transportation; and 5) Food stores.

In the embodiment of the invention as the venues change, and consumer spending habits change, information rendered to Internet users can be adjusted. Much emphasis is put upon the Internet user to pare down the search criteria to retrieve the information or business services they desire or need. The Internet user typically, regardless of search engine, enters exact words or phrases to get the business or services search results they desire. Search engines may also artificially grasp a concept the user may have sought and through algorithms and computer based logic a search result is finally rendered.

In known art, Internet user demographics is associated with a method for processing queries including: sorting queries into a plurality of subsets as well as concepts and comparisons. It is the embodiment of the invention to make common consumer interests and consumer spending categories more accessible and in geographically-centric areas with results that are not based on a textual search, the use of search engines or based on computer logic or algorithms.

Although the invention has been associated with a business model of the vertical markets hotels and coffee shops, it will be appreciated that the invention is intended for all public and private providers of Internet services and the general populous of residents of communities everywhere and covers any modification within the scope of the following claims.

### DESCRIPTION OF DRAWINGS AND IMAGES

FIG. 1

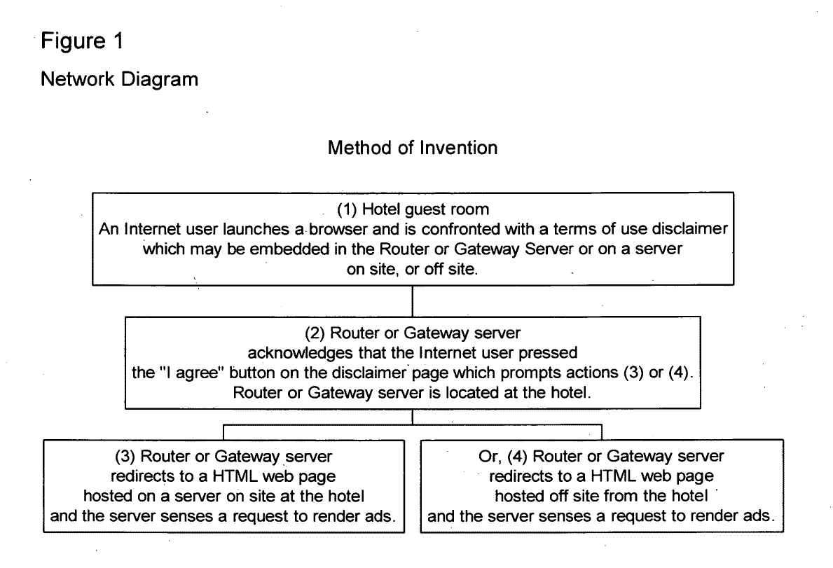

A network diagram that shows the flow of information from a hotel guestroom where an Internet user summons up Internet services from a router or gateway server; from the router or gateway server to the options of an advertising database server located on site or located off site at a server farm, or hosted Internet Service Provider.

FIG. 2

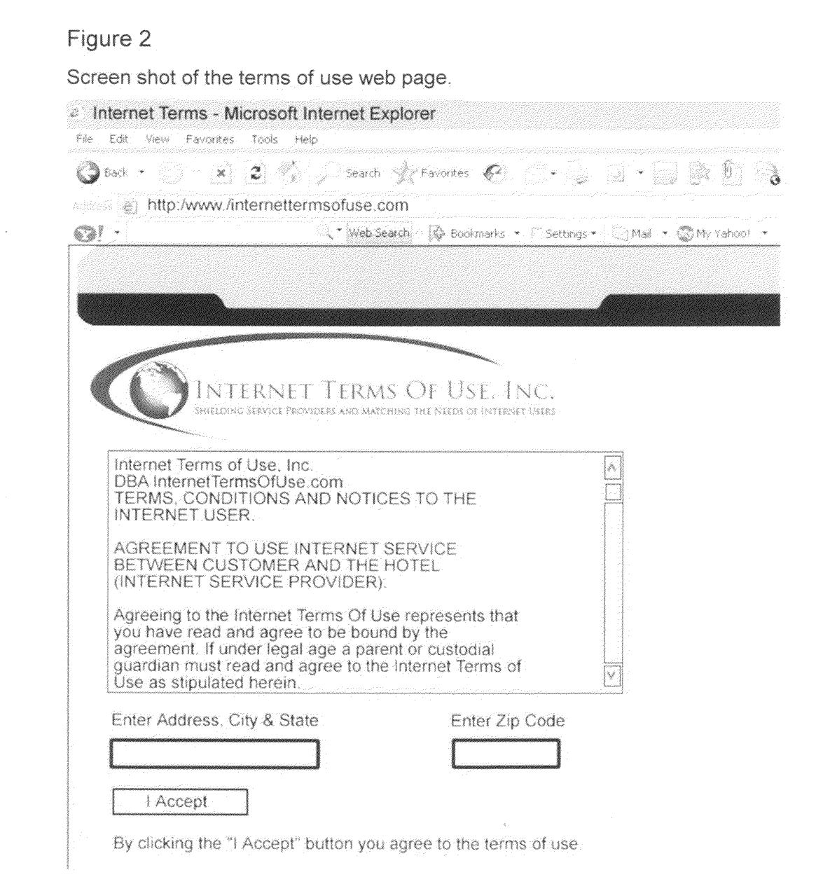

A illustration of the Internet Terms of Use disclaimer page with a text box to input user address and a hyperlink action button that when pressed redirects the Internet user to a HTML web page where advertising appears.

FIG. 3

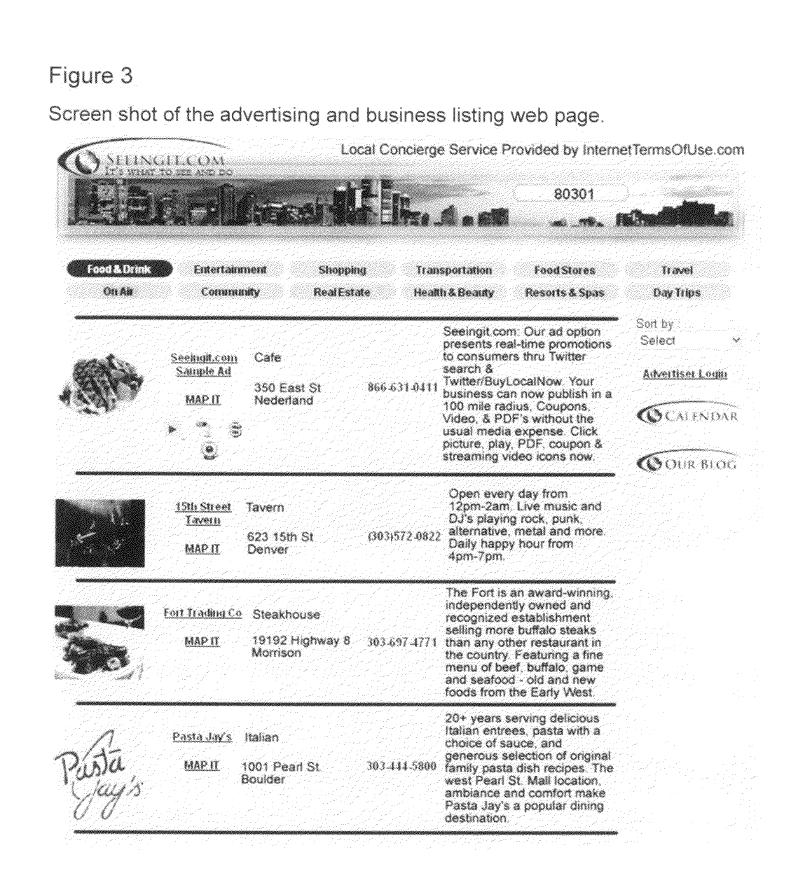

A illustration of the rendered information and advertiser web page.

FIG. 4

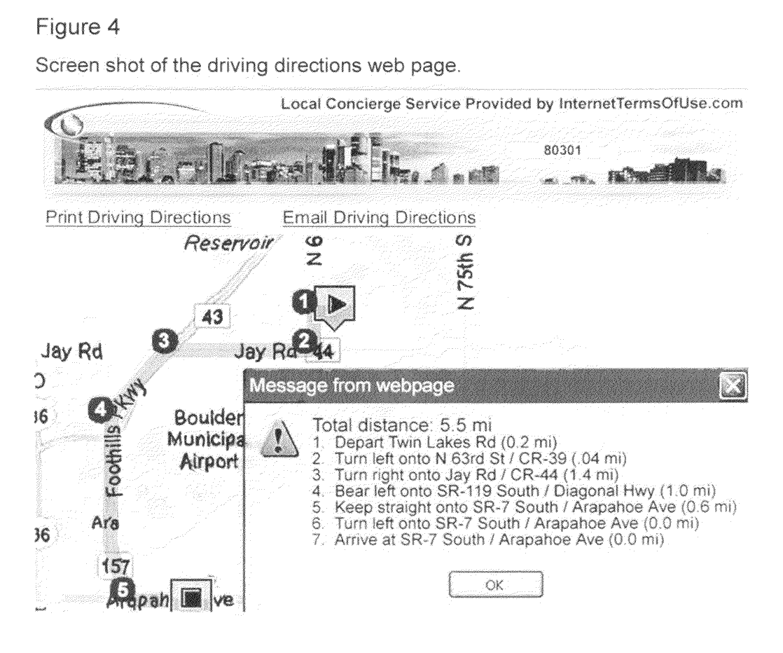

A illustration of the driving directions web page.

We claim:

1. A method to render information, services and advertisements that pertain to the interests of an Internet user which does not require the processing of a search request or analyzing of a query containing a string of one or more words in a textual field box.

2. A method to render customized information, services and advertisements residing in a database which is accessed by the inputting of an address in a textual field box and its logic derived from specific consumer spending habits and tourism research.

3. A method to render customized information, services and advertisements which does not require the processing of a search request or analyzing of a query containing a string of one or more words in a textual field box.

4. A method to render information, services and advertisements based on trends, consumer spending habits and tourism research consolidated using the address and zip code location of the Internet user, or other identifying means

5. The method to render information, services and advertisements while mobile wherein the address locations change, and is electronically captured to render a refreshed web page or HTML received by web enabled computing device for example a computer, a hand-held device or a car equipped with GPS and screen.

6. The method of claim 1 wherein driving directions are rendered to services, advertisers and places of interest without having to enter in a textual field box a from and a to address location.

7. The method of claim 1 wherein driving directions are rendered to services, advertisers and places of interest in one step of clicking on a Map link.

8. The method of claim 1 wherein services and advertisements is rendered in a geographically-centric area, for example based on a region or zip code.

9. The method of claim 1 wherein services and advertisements is rendered on a HTML web page designed around the type of Internet service provider venue.

10. The method of claim 1 wherein services and advertisements is rendered to community residents.

11. The method of claim 1 wherein services and advertisements is rendered to hotel guests, or guests using Internet from a public provider.

12. The method of claim 1 wherein services and advertisements is rendered on a HTML web page designed around a vertical market Internet provider venue.

13. The method of claim 1 wherein services and advertisements are rendered on a HTML web page designed around the demographic configuration of Internet users at a particular venue.

14. The method of claim 1 wherein services and advertisements is rendered on a HTML web page designed around the time of day at any venue.

15. The method of claim 1 wherein the rendered services and advertisements is a result of pre-sold contracts with an obligation to display said advertisements at a particular Internet provider venue.

16. The method of claim 1 wherein the rendered services and advertisements can be random and adjust according to the type of Internet service provider venue.

17. The method of claim 1 wherein a piece of hardware such as a router or an Internet gateway server has a feature that allows embedded HTML code which could be comprised of the services and advertisements to be rendered to the Internet user.

18. The method of claim 1 wherein the rendered information or advertisements that meet the interests of the Internet venue demographic is on a HTML web page.

19. The method of claim 1 wherein services and advertisements is rendered in a succinct line item or display type advertising format with headings that are comprised of the researched topics most sought by Internet users at a particular venue.

20. The method of claim 1 wherein a computer server containing the database of advertisers is located on the site of the Internet service provider venue.

21. The method of claim 1 wherein a computer server containing the database of advertisers is located off the site of the Internet service provider venue.

22. The method of claim 1 wherein an initial welcoming page or a terms of use page is displayed on a computer screen and contains an “I accept” or other action button that hyperlinks to a second HTML web page which is the page that contains rendered advertisements.

23. The method of claim 1 wherein the Internet user demographics of the venue determine suitable advertisers.

24. The method of claim 1 wherein the rendered advertisements to a specific Internet user demographic is not related to a computer search, computer based logic or algorithms, the processing of queries, a method of sorting queries, the performing of comparisons, search concept analysis or trend information, but rather the demographic the Internet service provider attracts.

25. The method of claim 1 wherein suitable advertisers are sought contractually by Internet Terms of Use, Inc. (the Company).

26. The method of claim 1 wherein suitable advertisers are sought contractually by the venue.

27. The method of claim 1 wherein the database of advertisers is supplied to the Internet user from a variety of sources including: a local area network (LAN); a wide area network (WAN); a Satellite; a Fiber Optic Network; a local telecommunications provider; a microwave delivery system or data transmission from any other source.

28. The method of claim 1 wherein a piece of hardware between the Internet and the Internet user such as a Internet gateway requires the Internet user to input their location address and or user ID.

29. The method of claim 1 wherein the HTML web page design requires the Internet user to input their location address and or user ID.

30. The method of claims 19 and 20 wherein a RADIUS server on the network captures information and authenticates the Internet user on the network.

31. The method of claims 19 and 20 wherein the RADIUS server captures the Internet users IP address for tracking and security purposes.

32. A multi-functioning Internet portal system that consists of an Internet Terms Of Use policy; a welcoming page; an advertising platform for businesses near the Internet service provider venues and national advertisers; an eCommerce storefront; a technical support portal for Internet service and telephone PBX support and any other services or features that fit within the scope of the Internet service provider venue or Internet user at the venue.

33. The system of claim 23 wherein a Internet service provider venue can directly make purchases of products or services from the web site.

34. The system of claim 23 wherein the Internet user can make product purchases or event reservations directly from the web site.

35. The system of claim 23 wherein a chat session window can be initiated on the web site by an Internet user.

36. The system of claim 23 wherein an Internet user can initiate on the web site a voice over Internet protocol (VoIP) telephone call.

37. The system of claim 23 wherein an Internet user on the web site can initiate a streaming media session.

38. The system of claim 23 wherein an Internet user on the web site can initiate a two-way video conference.
